(19) United States
(12) Patent Application Publication
(10) Pub. No.: US 2007/0254711 A1
(43) Pub. Date: Nov. 1, 2007

(54) Accessing a SIM card to obtain configuration information by a remote embedded communication module

(76) Inventors: David Charles Young, Cary, NC (US); Michael William Ripp, Raleigh, NC (US)

Correspondence Address: COATS & BENNETT/SONY ERICSSON, 1400 CRESCENT GREEN, SUITE 300, CARY, NC, 27511, US

(21) Appl. No.: 11/411,519

(22) Filed: Apr. 26, 2006

(51) Int. Cl. H04B 1/38

(52) U.S. Cl. 455/558

(57) ABSTRACT

A remote embedded wireless communication module obtains configuration information by accessing a Subscriber Identification Module (SIM) card. The configuration information may be preprogrammed onto the SIM card. Alternatively, the SIM card may include initial session information allowing the remote embedded wireless communication module to establish a communication session with a central server, and download the configuration information. As another alternative, the initial session information may be transmitted to the remote embedded wireless communication module via a Short Message System (SMS) transmission.

### BACKGROUND

The present invention relates generally to the field of remote embedded wireless communication modules and in particular to a method of accessing a SIM card to obtain configuration information or initial session information.

With the explosive growth of cellular wireless communications (e.g., cell phones), the establishment of a substantial cellular infrastructure, together with the reduced cost of wireless transceivers through integration, have prompted the integration of remote embedded wireless communication modules into a wide range of products and applications.

For example, the OnStar® service available in many new automobiles relies on a GPS receiver coupled to a remote embedded wireless communication module to provide remote vehicle tracking services (such as theft recovery and reporting vehicle location to emergency services upon detection of airbag deployment) and remote control services (such as remotely unlocking doors, executing vehicle diagnostics, and the like).

As another example, many new vending machines include a remote embedded wireless communication module to wirelessly report their inventory of goods. This eliminates the need for periodic visits to each vending machine by service personnel, as personnel need only be deployed to service the vending machines on an as-needed basis. Additionally, it maximizes revenue by avoiding the loss of sales when a vending machine empties prior to a scheduled service visit.

As a still another example, remote embedded wireless communication modules are integrated into utilities meters, such as natural gas meters, electricity meters, water meters, and the like. Meters having wireless communication ability may periodically report their state, completely eliminating the need for periodic visits by “meter readers.”

While remote embedded wireless communication modules present many advantages, programming the modules remains problematic. The modules are programmed by the integrator to perform the specific wireless communication tasks required for a particular application. For example, a meter reading application may place Circuit Switched Data (CSD) calls, while a vehicle tracking application may use Internet Protocol (IP) sessions over GPRS. This application-specific programming—referred to herein as configuration information—is typically loaded into a remote embedded wireless communication module upon its initial power-up via a UART or USB connection. This requires a computer and manual intervention, which can be costly and time-consuming when large quantities of modules are involved, and/or the modules are deployed in the field

### SUMMARY

According to one or more embodiments of the present invention, remote embedded wireless communication module configuration information is obtained by accessing a Subscriber Identification Module (SIM) card, which is required for each module to access to the wireless communication network. The configuration information may be preprogrammed onto the SIM card. Alternatively, the SIM card may include initial session information allowing the remote embedded wireless communication module to establish a communication session with a central server, and download the configuration information. As another alternative, the initial session information may be transmitted to the remote embedded wireless communication module via a Short Message System (SMS) transmission.

In one embodiment, the present invention relates to a method of initializing a remote embedded wireless communication module having a SIM card. The SIM card is accessed upon module power-up to obtain configuration information comprising a plurality of commands, and the commands are executed to initialize the module.

In another embodiment, the present invention relates to a method of initializing a remote embedded wireless communication module having a SIM card. Initial session information is received via a SMS transmission. The initial session information is used to contact a central server. Configuration information comprising a plurality of commands is downloaded from the central server, and the commands are executed to initialize the module.

In yet another embodiment, the present invention relates to a remote embedded wireless communication module. The module includes a SIM card including memory and a wireless transceiver. The module also includes a controller operative to control the wireless transceiver, and further operative to access the SIM card upon module power-up to obtain configuration information comprising a plurality of commands, and to execute the commands.

In still another embodiment, the present invention relates to a remote embedded wireless communication module. The module includes a SIM card including memory and a wireless transceiver. The module also includes a controller operative to control the wireless transceiver. The controller is further operative to receive initial session information via a SMS transmission; use the initial session information to contact a central server; download configuration information comprising a plurality of commands from the central server; and execute the commands to initialize the module.

### BRIEF DESCRIPTION OF DRAWINGS

FIG. 1 is a functional block diagram of a remote embedded wireless communication module.

FIG. 2 is a flow diagram of methods of a remote embedded wireless communication module accessing configuration information.

### DETAILED DESCRIPTION

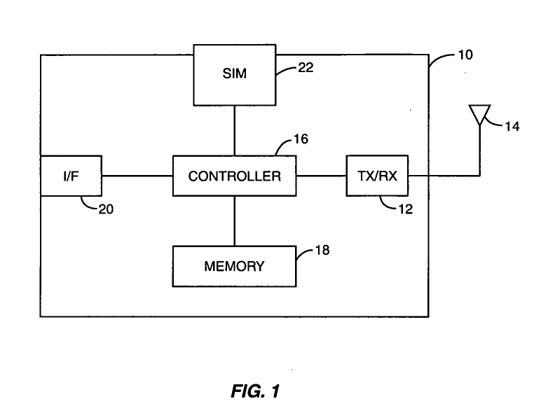

FIG. 1 depicts a functional block diagram of a remote embedded wireless communication module 10. The module 10 includes wireless transceiver circuits 12 connected to an antenna 14. The transceiver 12 is operative to communicate with a wireless communication network according to one or more industry-standard protocols, such as GSM, UTMS, CDMA, or the like. The transceiver 12 is controlled by a controller 16, which may comprise a microprocessor, digital signal processor (DSP), embedded microcontroller, or the like. The controller 16 is operatively connected to memory 18, which may comprise DRAM, SRAM, ROM, or the like. An interface circuit 20, which may comprise a UART, USB controller, or the like, allows service personnel to program configuration information into the module 10 upon power-up.

The remote embedded wireless communication module 10 also includes a removable Subscriber Identity Module (SIM) card 22. As well known in the wireless arts, a SIM card 22 provides secure storage of the International Mobile Subscriber Identity (IMSI) which uniquely identifies a mobile communication service subscriber. The SIM card 22 may also store subscription information, network parameters, subscriber preferences, and the like. As used herein, the SIM card 22 includes the Universal Subscriber Identity Module (USIM) required in UMTS networks.

According to one or more embodiments of the present invention, the SIM card 22 stores configuration information required for a remote embedded wireless communication module 10 to fulfill a particular application. The configuration information typically comprises a script containing AT commands that control the module. When the module 10 powers up, the controller 16 automatically reads the SIM card 22 to obtain the IMSI and other network parameters. If configuration information is present on the SIM card 22, the configuration information is read and the commands are executed by the controller 16. In this manner, the remote embedded wireless communication module 10 may be initialized without the need for service personnel to physically connect a computer to the module 10. Rather, the configuration information may be provided to the SIM card 22 provisioner, who includes the relevant configuration information on the SIM card 22 prior to the SIM card 22 being installed in the remote embedded wireless communication module 10.

In one embodiment, rather than the actual configuration information, initial session information (e.g., information needed to establish an IP connection) is preprogrammed on the SIM card 22. The initial session information may include an IP address for the module 10, the IP address of a central server, and additional information such as which protocols to use and the like. When the remote embedded wireless communication module 10 powers up, it reads the initial session information from the SIM card 22, and then establishes a connection to a central server where the configuration information is stored. The remote embedded wireless communication module 10 downloads the configuration information from the central server, and executes the commands. This embodiment may be particularly advantageous in situations where the required functionality of the remote embedded wireless communication module 10 changes frequently.

In another embodiment, the initial session information is transmitted to the remote embedded wireless communication module 10 via a Short Message Service (SMS) transmission. The remote embedded wireless communication module 10 uses the initial session information received via SMS to establish a communication session with a central server, and downloads the configuration information. In either of these two embodiments (i.e., initial session information stored on the SIM card 22 or transmitted via a SMS message), once the module 10 downloads the configuration information from the central server, it preferably stores the configuration information to the SIM card 22. On subsequent initializations—such as when the module 10 again powers up—the controller 16 may read the configuration information from the SIM card 22 and avoid the download process.

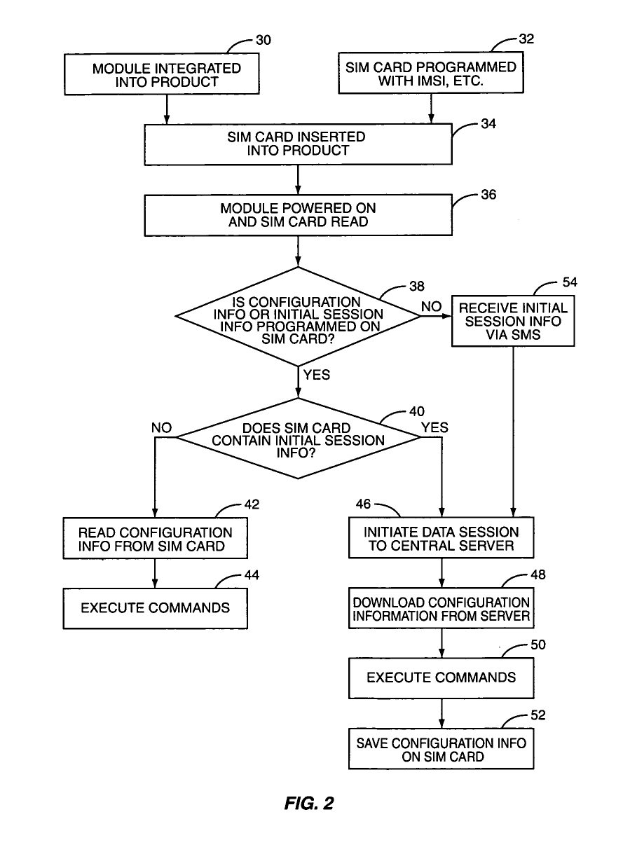

FIG. 2 depicts various methods of initializing a remote embedded wireless communication module 10, in flow diagram form. Initially, a remote embedded wireless communication module 10 is integrated into a product, such as a vehicle tracking system, vending machine, utility meter, or other product (block 30). A SIM card 22 is programmed with an IMSI and other information necessary to enable the remote embedded wireless communication module 10 to access a wireless communication network (block 32). The SIM card 22 is inserted into the remote embedded wireless communication module 10 in the product (block 34). When the remote embedded wireless communication module 10 is powered on, the controller 16 reads information from the SIM card 22. The controller 16 determines whether configuration information or initial session information has been programmed onto the SIM card 22 (block 38). If so, the controller 16 determines whether the SIM card 22 contains initial session information (block 40). If not (i.e., if the SIM card 22 contains configuration information), the controller 16 reads the configuration information from the SIM card 22 (block 42), and executes the commands (block 44).

If the controller 16 determines that the SIM card 22 includes initial session information (block 40), it initiates a data session to a central server (block 46). Once a data session with the central server is established, the remote embedded wireless communication module 10 downloads configuration information from the central server (block 48), and executes the commands (block 50). The controller 16 may additionally save the configuration information to the SIM card 22 (block 52), to avoid the necessity of the download process upon a future initialization of the remote embedded wireless communication module 10.

If neither configuration information nor initial session information are found on the SIM card 22 (block 38), the remote embedded communication module 10 may receive the initial session information via a SMS message from the wireless network (block 54). Once it has initial session information, the remote embedded wireless communication module 10 may proceed to download, execute, and store session information, as described above (blocks 46-52).

As used herein, a remote embedded communication module 10 is an electronic device that is integrated into various applications to provide wireless communication functionality. The remote embedded communication module 10 is distinct from a personal wireless communication device, such as a cellular communication system mobile station or access terminal (i.e., cell phone) which provides voice and data communications for an individual.

Although the present invention has been described herein with respect to particular features, aspects and embodiments thereof, it will be apparent that numerous variations, modifications, and other embodiments are possible within the broad scope of the present invention, and accordingly, all variations, modifications and embodiments are to be regarded as being within the scope of the invention. The present embodiments are therefore to be construed in all aspects as illustrative and not restrictive and all changes coming within the meaning and equivalency range of the appended claims are intended to be embraced therein.

What is claimed is:

1. A method of initializing a remote embedded wireless communication module having a Subscriber Identification Module (SIM) card, comprising:
accessing the SIM card upon module power-up to obtain configuration information comprising a plurality of commands; and
executing the commands to initialize the module.

2. The method of claim 1 wherein the SIM card is preprogrammed to include the configuration information.

3. The method of claim 1 wherein the SIM card is preprogrammed to include initial session information, and wherein accessing the SIM card upon module power-up to obtain configuration information comprises accessing the SIM card to obtain the initial session information, and further comprising, prior to executing the commands:
using the initial session information to contact a central server; and
downloading configuration information comprising a plurality of commands from the central server.

4. The method of claim 3 further comprising storing the configuration information on the SIM card.

5. The method of claim 4 further comprising, on subsequent initializations, reading the configuration information from the SIM prior to executing the commands.

6. A method of initializing a remote embedded wireless communication module having a Subscriber Identification Module (SIM) card, comprising:
receiving initial session information via a Short Message System (SMS) transmission;
using the initial session information to contact a central server;
downloading configuration information comprising a plurality of commands from the central server; and
executing the commands to initialize the module.

7. The method of claim 6 further comprising storing the configuration information on the SIM card.

8. The method of claim 7 further comprising, on subsequent initializations, reading the configuration information from the SIM card prior to executing the commands.

9. A remote embedded wireless communication module comprising:
a Subscriber Identification Module (SIM) card including memory;
a wireless transceiver; and
a controller operative to control the wireless transceiver, and further operative to access the SIM card upon module power-up to obtain configuration information comprising a plurality of commands, and to execute the commands.

10. The module of claim 9 wherein the SIM card is preprogrammed to include the configuration information.

11. The module of claim 9 wherein the SIM card is preprogrammed to include initial session information, and wherein the controller is operative to access the SIM card upon module power-up to obtain initial session information, and is further operative to use the initial session information to contact a central server download configuration information comprising a plurality of commands from the central server, prior to executing the commands.

12. The module of claim 11 wherein the controller is operative to save the configuration information to memory on the SIM card, and on subsequent initializations, is operative to read the configuration information from the SIM card prior to executing the commands.

13. A remote embedded wireless communication module comprising:
a Subscriber Identification Module (SIM) card including memory;
a wireless transceiver; and
a controller operative to control the wireless transceiver, and further operative to:
receive initial session information via a Short Message System (SMS) transmission;
use the initial session information to contact a central server;
download configuration information comprising a plurality of commands from the central server; and
execute the commands to initialize the module.

14. The module of claim 13 wherein the controller is further operative to store the configuration information in memory on the SIM card.

15. The module of claim 13 wherein the controller is further operative to, on subsequent initializations, read the configuration information from the SIM card prior to executing the commands.
